(19) United States
(12) Patent Application Publication
(10) Pub. No.: US 2013/0279478 A1
(43) Pub. Date: Oct. 24, 2013

(54) Methods and Arrangements in a Cellular Communication System

(71) Applicants: Peter De Bruin, Gammelstad (SE); Bo Hagerman, Tyreso (SE); Sara Landström, Lulea (SE); Arne Simonsson, Gammelstad (SE); Bogdan Timus, Spanga (SE)

(72) Inventors: Peter De Bruin, Gammelstad (SE); Bo Hagerman, Tyreso (SE); Sara Landström, Lulea (SE); Arne Simonsson, Gammelstad (SE); Bogdan Timus, Spanga (SE)

(73) Assignee: TELEFONAKTIEBOLAGET L M ERICSSON (PUBL), Stockholm (SE)

(21) Appl. No.: 13/995,438

(22) PCT Filed: Dec. 22, 2010
(86) PCT No.: PCT/SE2010/051453

§ 371 Date: Jun. 18, 2013

(51) Int. Cl. H04W 36/30

(52) U.S. Cl. CPC H04W 36/30
USPC 370/331

(57) ABSTRACT

Methods and arrangements in network nodes in a cellular communication system The methods and arrangements relate to the delegation of serving functions, associated with a mobile terminal, from one node to another The method and arrangement in a delegating entity relate to obtaining (1002) information on the mobile terminal and at least one access point, and analyzing said information The method and arrangement further relates to determining (1006), based on the analysis and predefined criteria, whether a second access point is more suitable than a first access point for executing one or more serving functions related to the mobile terminal When a second access point is found to be more suitable for executing one or more of the serving functions, the delegating node may arrange (1008) such that the one or more serving functions are delegated from the first access point to the second access point

### TECHNICAL FIELD

The invention relates to a method and arrangement for improving the efficiency of a cellular network and for enabling simple and efficient management of a cellular network.

### BACKGROUND

The different nodes in heterogeneous networks may have different capabilities, such as e.g. maximum transmit power, processing capabilities, antenna arrangements and/or backhaul capacity. For example, the different nodes may be e.g. macro base stations, micro base stations or relays. The differences in transmit power level between the nodes may be as high as 10-20 dB, which results in cells of various sizes if the cell selection is based on the received power level of some reference signal or pilot.

The differences between the nodes in e.g. transmit power level, associated cell size and/or processing capabilities could be used by the operators to deploy and run the networks more efficiently. Below, one recently suggested example of such usage will be presented, which example has been briefly described in reference [1].

One example is related to the asymmetry between downlink and uplink that occurs when base stations have different transmit power levels. On the downlink, a UE should ideally be connected to the base station from which the highest power is received. Since the base stations transmit with different powers, the “best” base station, in terms of received power, is not necessarily the one with the lowest pathloss to the UE. On the uplink, however, a UE should ideally be connected to the base station with the lowest pathloss, since that base station will receive the highest signal strength from the UE. Therefore, it may be desirable to enable different cell selection criteria on the uplink and on the downlink.

FIG. 1 shows an example illustrating UL/DL asymmetry, comprising three UEs and two base stations (BSs). UE1 should, according to the rules described below, be connected to BS1 both on the uplink and on the downlink, since the pilot power received from BS1 is the highest (downlink), and, the pathloss to BS1 is the lowest (uplink). Similarly, UE3 should be connected to BS2, both on the uplink and on the downlink, since the pilot power received from BS2 is the highest and the pathloss to BS2 is the lowest. However, UE2 is located in a transit area, where it should ideally be connected to BS1 on downlink and to BS2 on the uplink. The size of this transient area depends on the power difference between BS1 and BS2. It should be noted that the illustrated “independent” UL/DL allocation is not standardized, nor implemented.

Today, in Long Term Evolution (LTE), the serving base station, or Evolved eNodeB (eNB), has the responsibility for the radio resource related functions of a UE. At a handover, all responsibility is taken over by the new serving eNB. The decision of when to make a handover is complicated, and often there is a trade-off between the conditions for different functions. As networks become more heterogeneous and more coordination between nodes is introduced, the handover decision becomes even harder. In heterogeneous networks there are eNBs with different power levels, whereas most UEs, on the other hand, have relatively similar maximum transmit power. Therefore, the optimal criterion may be different e.g. for the downlink and for the uplink, respectively. Furthermore, today, all UEs are treated alike, regardless of where they are relative other eNBs and what information that is available in the eNBs.

### SUMMARY

It would be desirable to obtain improved conditions for the serving of UEs. Further, it is an object of the invention to provide methods and arrangements enabling improved conditions for the serving of UEs. These objects may be met by a method and arrangement according to the attached independent claims. Exemplifying embodiments are defined by the dependent claims.

According to a first aspect, a method is provided in a network node managing a mobile terminal in a cellular communication system. The method comprises obtaining information on the mobile terminal and at least one access point, and analyzing the obtained information. The method further comprises determining, based on the analysis and predefined criteria, whether a second access point is more suitable than a first access point for executing one or more serving functions related to the mobile terminal. When a second access point is found to be more suitable for executing one or more of the serving functions, arranging such that the one or more serving functions are delegated from the first access point to the second access point, while keeping the overall responsibility for the managing of the mobile terminal.

According to a second aspect, an arrangement is provided in a first network node in a cellular communication system. The arrangement comprises a functional unit, which is adapted to obtain information on a mobile terminal managed by the first network node, and at least one access point. The arrangement further comprises a functional unit, which is adapted to analyze the obtained information. The arrangement further comprises a functional unit, which is adapted to determine, based on the analysis and predefined criteria, whether a second access point is more suitable than a first access point for executing one or more serving functions related to the mobile terminal. The arrangement further comprises a functional unit, which is adapted to arrange such that the one or more serving functions are delegated from the first access point to the second access point, while the overall responsibility for the managing of the mobile terminal is kept in the first network node.

According to a third aspect, a method is provided in an access point. The method comprises receiving a delegation request related to a serving function and a UE, from a requesting network node. The method further comprises determining whether the request could be accepted, and indicating the result of the determining to the requesting node.

According to a fourth aspect, an arrangement is provided in an access point. The arrangement comprises a functional unit, which is adapted to receive a delegation request from a requesting network node. The arrangement further comprises a functional unit, which is adapted to determine whether the request could be accepted or not. The arrangement further comprises a functional unit, which is adapted to indicate the result of the determining to the requesting node.

The above methods and arrangements provide a flexible mechanism for improving the network operation, with respect to various performance measures, in different scenarios. For example, through the provided dynamic and flexible framework for moving the responsibility for the execution of different functions between different nodes, it is possible to find individualized solutions for the corner cases where the main stream solutions are not suitable. The proposed framework can take into account changes in, e.g., UE positions and/or traffic load. It also allows each UE to be handled independently of other UEs.

This suggested solution supports distributed network operation. Heterogeneous networks are expected to be complex and to contain significantly more base stations than in a traditional network based on macro base stations. Hence, distributed operation, dynamically based on conditions for the individual UEs, is an important feature for network scalability and particularly network operation cost.

The above methods and arrangements may be implemented in different embodiments. The serving functions which may be delegated could be related to Radio Link Control and/or Radio Resource Control, and be related to e.g. HARQ, Link Adaptation, Power Control and/or Scheduling. The first and second access points may be base stations, and the first network node and the first access point could be the same node. Alternatively, the first network node could be a control node.

The delegation may involve transmission of a delegation order from the first network node (when being a control node) to the first access point. Alternatively, the delegation may involve the transmission of a delegation request to the second access point, which request may be accepted or rejected by the second access point. Further, information related to the at least one serving function to be delegated could be provided to the second access point, when required. Serving functions may be delegated to more than one access point.

When one or more serving functions related to a mobile terminal are delegated from the first access point to a second access, these serving functions may be revoked by the first network node when the second access point is no longer the most suitable for executing these functions. Such a revocation may involve the transmission of a revocation order to the second access point, identifying the at least one serving function to be revoked and the concerned mobile terminal.

Information enabling the execution of the at least one revoked serving function may be provided to the revoking network node, when required. In some embodiments, confirmations may be sent when a delegation has been successfully completed or revoked. In some embodiments, an access point may request to take over a serving function from another node, which request could be accepted or rejected.

Further, the first network node may resume a delegated function in case the node to which the function was delegated fails to execute said function, e.g. due to power failure.

The embodiments above have mainly been described in terms of a method. However, the description above is also intended to embrace embodiments of the arrangements, adapted to enable the performance of the above described features. The different features of the exemplary embodiments above may be combined in different ways according to need, requirements or preference.

### BRIEF DESCRIPTION OF THE DRAWINGS

The invention will now be described in more detail by means of exemplary embodiments and with reference to the accompanying drawings, in which:

FIG. 1 is a schematic view illustrating a cellular communication system.

FIG. 2a is a schematic view illustrating a UE changing position in a cellular communication system.

FIG. 2b is a signalling scheme between two access points when a UE serving function is delegated, according to an optional exemplifying embodiment.

FIGS. 3 and 4a are schematic views illustrating a UE changing position in a cellular communication system.

FIGS. 4b and 5 are signalling schemes between two access points when a UE serving function is delegated, revoked and requested, according to different optional exemplifying embodiments.

FIG. 6 is a schematic view illustrating a UE in a cellular communication system with two nodes with different transmit power levels.

FIG. 7-8 are schematic views illustrating delegation of UE serving functions from one access point to another, according to optional exemplifying embodiments.

FIG. 9 is a schematic view illustrating delegation of BS functions from one access point to other access points, according to an alternative optional exemplifying embodiment.

FIGS. 10-13 are flow charts illustrating delegation-related procedures performed in a network node, according to different optional exemplifying embodiments.

FIG. 14 is a block diagram illustrating an arrangement adapted for delegation of UE serving functions, according to an optional exemplifying embodiment.

FIGS. 15-17 are flow charts illustrating delegation-related procedures performed in an access point, according to different optional exemplifying embodiments.

FIGS. 18-19 are schematic views illustrating arrangements adapted for delegation-related actions, according to different optional exemplifying embodiments.

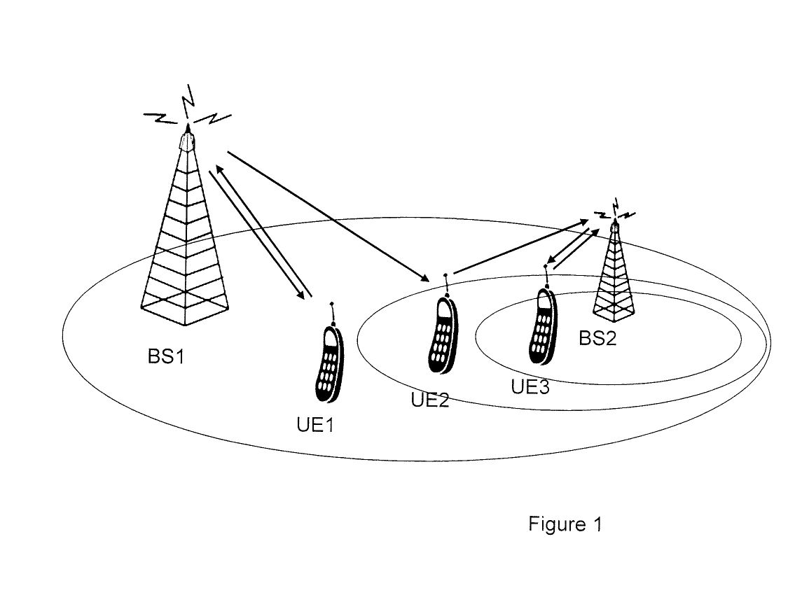

### DETAILED DESCRIPTION

It is realized that the management of each UE could be treated as a collection of functions. Further, it is realized that it could be made possible for a responsible node to delegate the execution of these functions to different other nodes in the network. It is further realized that the act of delegating and withdrawing or revoking delegated functions should be done individually and dynamically for each UE.

The concept of “handover” is well known. The performing of a handover implies that all functions related to the serving of a UE are moved from one serving node to another, based on mobility management. According to exemplifying embodiments presented in this document, only selected functions are delegated to other nodes. Moreover, functions associated with a UE may be delegated to several nodes, based on the situation. For instance, the decision to delegate or revoke a delegation may be based on (measured) relations to a served UE (and potentially interfering UEs), such as e.g. pathloss, output power or cell load. A consequence of this procedure is that different UEs may have different functional splits.

This document reveals a solution for enabling “delegation” of one or multiple selected functions between different nodes, based on other criteria than purely based on mobility management. One node can “delegate” one or more functions to another node, while maintaining others, for a given UE. This means that a UE may have more than one serving node, each performing different functions. This will within this document be denoted a “functional split”.

The described delegation approach can be said to bring a finer granularity to the handover concept. It is also important to stress that the functional split acts per UE, which means that different UEs can potentially utilize different nodes for different functionality, even if they happen to be geographically “close” to each other. Another important aspect is that functions related to control and data information may be separated and handled by different nodes.

The solution involves identifying selected functions, and objects (e.g. UEs), upon which functions are applied, and to delegate (or recall) the execution of these functions to (or from) other nodes. The solution will be exemplified below by a number of embodiments. The exemplifying message types and the content of the exemplifying messages can be further refined.

### Exemplifying Embodiment 1

### Delegating Functionality

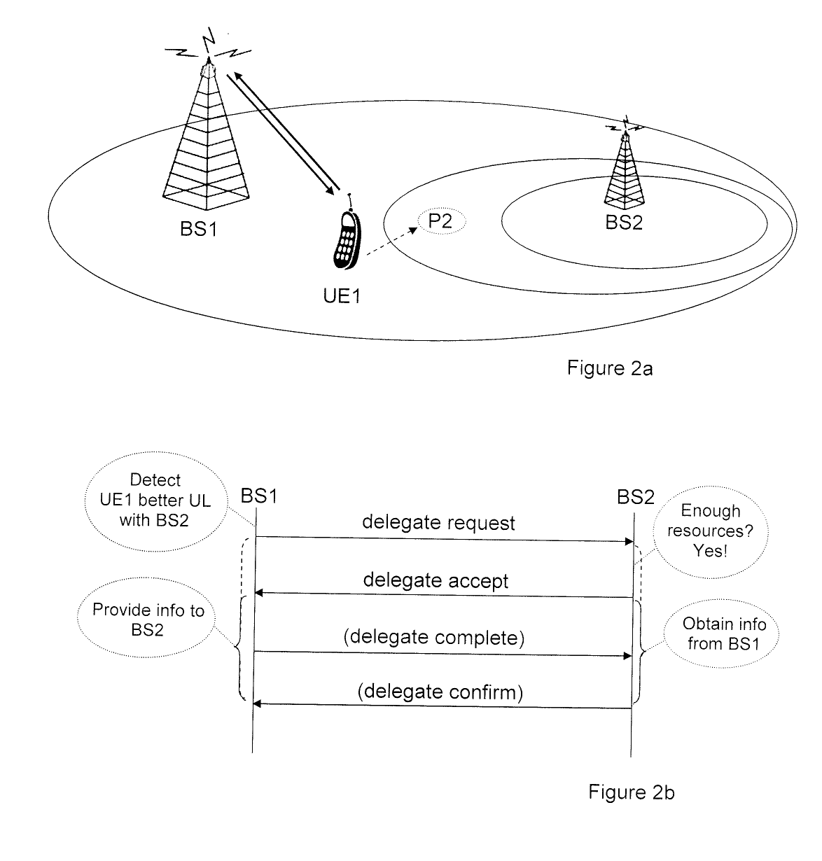

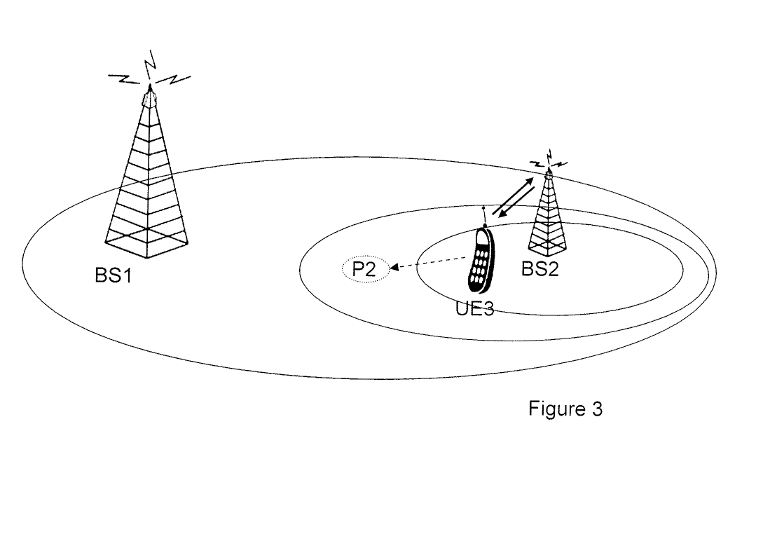

A first exemplifying embodiment will now be described with reference to FIG. 2, which shows two Base Stations (BSs), which also may be denoted access points, and a mobile terminal (UE). As illustrated in FIG. 2a, UE1 is solely served by BS1. According to standards such as e.g. LTE or WCDMA, UE1 monitors pilot signals received from neighboring cells and sends measurement reports to BS1. Thus, when UE1 moves towards the position marked “P2” in FIG. 2a, BS1 may detect that the UE1 would have a better uplink connection if UE1 was handed over to BS2, due to that the pathloss between UE1 and BS2 in that position is smaller than the pathloss between UE1 and BS1.

In this case, the following procedure may be initiated by BS1:
1 BS1 sends a delegate request message to BS2, which message indicates which function(s) should be taken over by BS2, “uplink data reception” in this case, and for which user or UE. It should be noted that the function denoted ‘data_uplink’ below could be delegated to more than one BS. Delegating ‘data_uplink’ to a plurality of BSs would enable e.g. so-called “opportunistic routing”, where any BS which correctly receives uplink data may forward the data. Without loss of generality, the message could contain:
   delegate(from=‘BS1’, to =‘BS2’, function=‘data_uplink’, object=‘UE1’)
2 Upon receiving the delegate request message, BS2 analyses whether it can take over the function, for instance if it has the processing capabilities needed for this operation. Then BS2 may accept or reject the delegation by answering the request using one of the following two messages:

delegate_accept(from = ’BS1’, to=’BS2’, function = ’data_uplink’,
object = ’UE1’)
delegate_reject(from = ’BS1’, to=’BS2’, function = ’data_uplink’,
object = ’UE1’)

3 If BS2 has accepted the delegation, BS1 may complete the delegation procedure, for example by sending the following message:
   delegate complete(from=‘BS1’, to=‘BS2’, function=‘data_uplink’, object=‘UE1’)
   The delegation_complete-message could also contain other data needed in order to enable BS2 to take over the execution of the ‘data_uplink’ function, such as e.g. the currently allocated radio resources, the type of bearers and/or services currently in use. Alternatively, at least parts of such data could e.g. be comprised in, or conveyed in association with, the delegation message.
4 An optional step in this procedure could be for BS2 to confirm that the delegation procedure has successfully been completed, by sending, for example, the following message:

delegate_confirmed(from = ’BS1’, to=’BS2’, function = ’data_uplink’,
object = ’UE1’)

The use of such a four-way handshaking would increase the reliability of the procedure, since it would avoid situations in which BS1 cease to provide the function to UE1, despite a failed delegation procedure. The above described delegation procedure is illustrated in FIG. 2b.

When completing a delegation procedure, which completion is initiated by the message sent at step 3 above, the base stations BS1 and BS2 may need to initiate an exchange of information, e.g. over the interface between BS1 and BS2 (denoted X2 in LTE). For example, BS2 may need to send its ACK/NACK messages related to data received from UE1, via BS1, so that BS1 can forward them to UE1 by sending them on the downlink. Moreover, BS1 may delegate other functions, such as monitoring, or forwarding to BS1, the measurement reports send by UE1. Also in this case, BS2 will forward the measurement reports sent by UE1, or an outcome of processing of these reports.

Another example of the use of the above described embodiment is when UE3 in FIG. 3 is served by BS2 and moves closer to the position marked by “P2”. Based on measurements reported by UE3, BS2 may estimate that UE3 would have a better downlink connection if it was served by BS1 on the downlink. In this case BS2 may use the above procedure to delegate the downlink functionality for UE1 to BS1.

### Exemplifying Embodiment 2

### Recalling Delegated Functionality

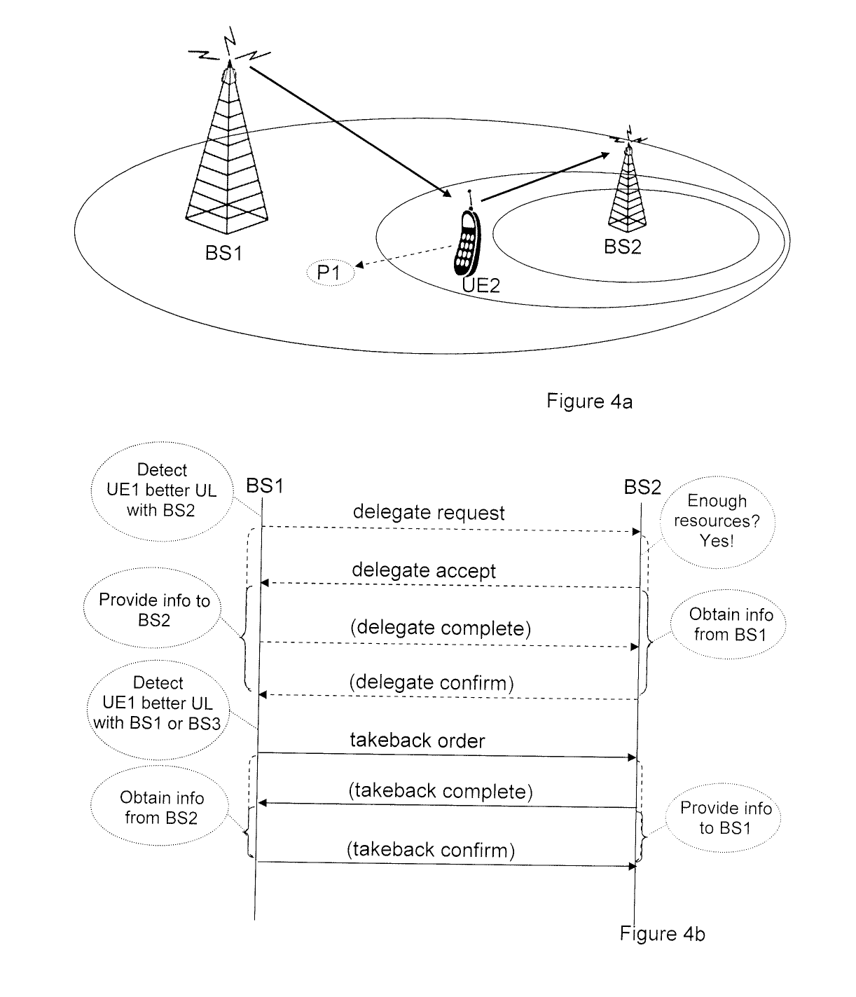

Below, a second embodiment will be described with reference to FIG. 4a. Assuming that UE2 is connected on downlink to BS1 and on uplink to BS2, as in FIG. 4a, after BS1 has delegated the uplink function(s) to BS2. Further assuming that UE2 is moving towards the position indicated in the figure by “P1”. Based on measurements from UE2, BS1 may decide that UE2 would have a better uplink connection if the uplink was served by BS1 instead of BS2.

In this case BS1 may initiate the following procedure:
1 BS1 sends a takeback request or order to BS2, in which the function(s) that are to be taken back from BS2 and for which object (UE), are indicated. Without loss of generality, the message could contain:
   takeback(from=‘BS2’, to =‘BS1’, function=‘data_uplink’, object=‘UE1’)
2 Upon receiving this request, BS2 may initiate the procedure of handing back the responsibility for the uplink function by sending the following message and any other data that might be needed to complete the transfer of responsibility:

takeback_complete (from = ’BS2’, to=’BS1’, function = ’data_uplink’,
object = ’UE1’)

3 In order to complete the procedure in a reliable way, BS1 could confirm the successful completion of the revocation process by sending the following message:
   takeback_confirm (from=‘BS2’, to=‘BS1’, function=‘data_uplink’, object=‘UE1’)

The above described procedure is illustrated in FIG. 4b. A generalization of the first two embodiments described above could be for BS1 to relocate the execution of a function from BS2 to a third base station BS3, by combining a takeback request sent to BS2 with a delegate request sent to BS3, and by properly indicating in the message from which BS to which BS the function should be relocated.

### Exemplifying Embodiment 3

### Requesting Delegation

Below, a third embodiment will be described, also with reference to FIG. 2a. Assuming that UE1 is connected both on uplink and on downlink to BS1, as shown in FIG. 2a. Further assuming that UE1 moves closer to the position marked “P2”, and by doing so, creating increased interference to BS2. However, BS2 cannot distinguish which UE(s) that are possibly causing said increase. In order to obtain information on the UE(s) possibly causing the increased interference, BS2 may request to take over, or rather ‘be enabled to perform’, uplink monitoring of all the UEs connected e.g. to BS1. BS2 may request to monitor the uplink traffic by sending the following message to BS1:

takeover(from=‘BS1’, to =‘BS2’, function=‘monitor_uplink’, object=‘all’)

Upon receiving this message, BS1 may answer with one of the following messages:

takeover_accept(from = ’BS1’, to=’BS2’, function = ’monitor_uplink’,
object = ’all’)
takeover_reject(from = ’BS1’, to=’BS2’, function = ’monitor_uplink’,
object = ’all’)

If BS1 accepts this request, it also provides BS2, e.g. over the X2 interface or Iub interface, with the necessary information for decoding the uplink signals sent by the UEs served by BS1, so that BS2 can monitor the uplink traffic. Necessary information is dependent on access technique and grade of monitoring. For LTE it can be scrambling code to enable decoding of uplink transmissions from a specific UE, sounding reference symbol positions to address monitoring frequencies and slots and/or control addressing information such as PUCCH (physical uplink control channel) code to decode reported CSI (Channel State Information) from the UE. This could be useful for instance for uplink interference canceling. Another application could be that BS2 can monitor the measurement reports sent by the UEs connected to other cells. It should be noted that monitoring functions may be performed by more than one access point. Thus, BS1 may continue to monitor e.g. the uplink traffic also after delegating this function to BS2.

BS1 may nonetheless reject such a request, for example, due to security reasons. Assuming, for example, that BS2 is a home base station and that BS1 is a macro base station. In this case, it might not be appropriate to let BS2 know which UEs that are served in the macro cell, or give BS2 the possibility to decode the uplink traffic sent by these UEs.

However, if BS2 is allowed by BS1 to monitor the signals sent by the UEs connected to BS1, then BS2 may also receive the measurement reports sent by UE1. Based on these reports, BS2 may estimate that the uplink of UE1 would have better performance if it was connected to BS2 instead of BS1.

In this case BS2 may initiate the following procedure:
1 BS2 sends a takeover request to BS1:
   takeover(from=‘BS1’, to=‘BS2’, function=‘data_uplink’, object=‘UE1’)
2 BS1 may answer BS2 using one of the following messages.

takeover_accept(from = ’BS1’, to=’BS2’, function = ’data_uplink’,
object = ’UE1)
takeover_reject(from = ’BS1’, to=’BS2’, function = ’data_uplink’,
object = ’UE1)

3 If BS1 accepts to delegate the data_uplink function to BS2, the transfer procedure may be initialized by BS1 sending the message:

takeover_complete(from = ’BS1’, to=’BS2’, function = ’data_uplink’,
object = ’UE1’)

4 For increasing the reliability of the procedure, BS2 may confirm the successful completion of the procedure by sending the message:

takeover_confirm(from = ’BS1’, to=’BS2’, function = ’data_uplink’,
object = ’UE1’)

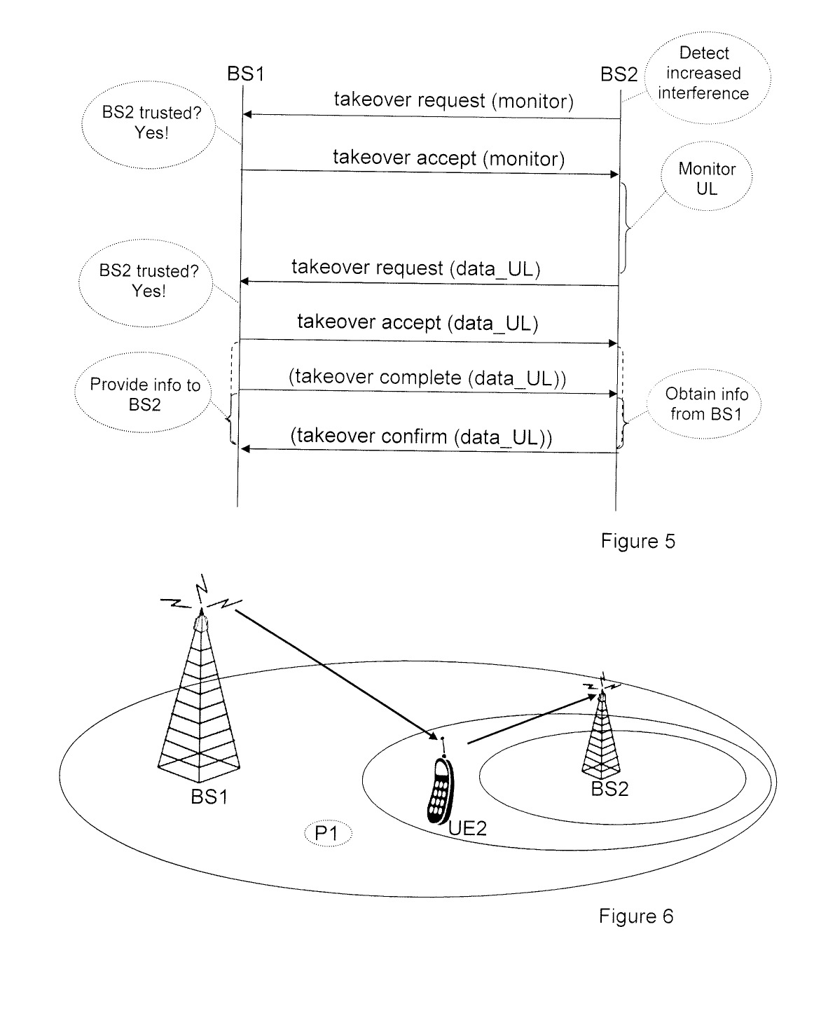

The last two steps above, 3-4, are essentially the same as for the procedure of delegating the function. The major difference is that the delegating procedure is initiated by the node that currently executes the function, while in the current embodiment the procedure is initiated by another node. The procedure described above is illustrated in FIG. 5.

### Exemplifying Embodiment 4

### Delegating HARQ

The delegation of functions can be performed based on where information is available, in order to minimize, e.g. delay, information interchange and/or communication load. One example is the delegation of uplink HARQ for UE2 from BS1 to BS2 in FIG. 6. As BS1 is a high power node and BS2 a low power node in this example, the uplink data from US2 is first available in the low power node BS2. The high power node can then delegate the HARQ functionality to the low power node for that UE e.g. as follows:

delegate(from=‘BS1’, to=‘BS2’, function=‘uplink HARQ, object=‘UE2’)
All other functionality for UE2 may be maintained by BS1 and the serving functions of other UEs need not to be affected. For example, the HARQ function for a UE located in the position illustrated as “P1” in FIG. 6 could remain in BS1.

The HARQ ACK/NACK can be sent from BS2 to BS1 and forwarded to UE2. The forwarding of ACK/NACK will result in much less information sent on the backhaul, as compared to when forwarding the full coded data reception. The ACK/NACK could also be sent directly from BS2 to UE2 and thereby shorten the HARQ delay.

Alternatively, if the low power node would have the main responsibility of the exemplified UE2, the delegation procedure would apply on the downlink and from BS2 to BS1, since the data is sent from BS1 to UE2:

delegate(from=‘BS2’, to=‘BS1’, function=‘downlink HARQ, object=‘UE2’)

### Exemplifying Embodiment 5

### Delegating Link Adaptation and Power Control

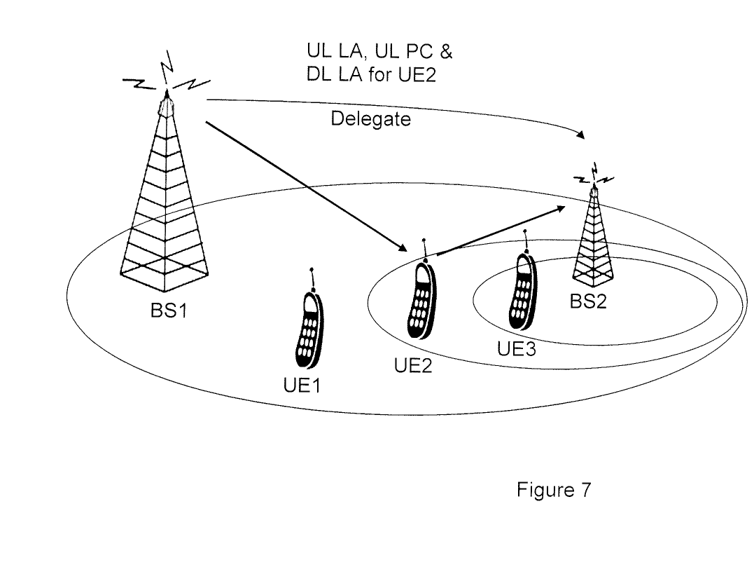

In analogy with the HARQ delegation, the link adaptation (LA) can be delegated to a node where the result of radio measurements is available. In the example of UE2 in FIG. 7, the uplink radio quality measures are performed by BS2 and uplink LA should therefore, preferably, be performed by BS2, such as:

delegate(from=‘BS1’, to=‘BS2’, function=‘uplink LA’, object=‘UE2’)
The selected transport format (MCS, modulation and coding scheme) can then be sent to UE2 via BS1 in LTE, or directly to UE2.

Uplink closed loop power control is, as LA, based on uplink quality measures and could similarly be delegated to the low power node, as follows:

delegate(from=‘BS1’, to=‘BS2’, function=‘uplink PC, object=‘UE2’)

For TDD (Time Division Duplex) downlink LA can be based on uplink radio measures done by BS1. Therefore may downlink HARQ gain from being allocated to the low power node for TDD:

delegate(from=‘BS1’, to=‘BS2’, function=‘downlink LA, object=‘UE2’)

### Exemplifying Embodiment 6

### Delegating Scheduling

In advanced schedulers, such as ICIC (Inter-Cell Interference Coordination) based schedulers and CoMP (Coordinated Multi-Point) schedulers, information from several nodes are taken into account.

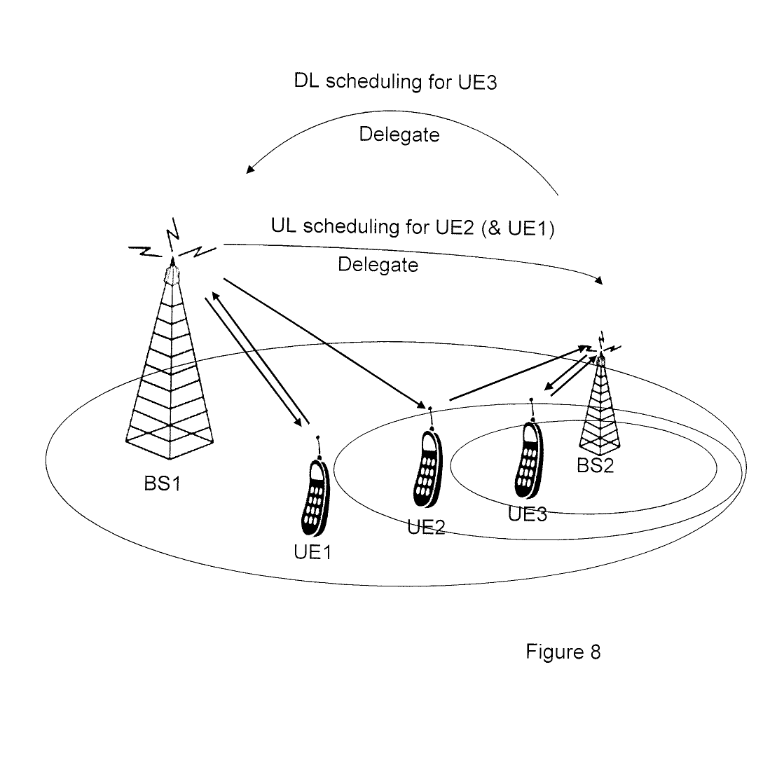

For ICIC, the scheduling decision for a certain UE is based on measurements originally available in several nodes. For the UE2 in FIG. 8, the interference in uplink is most severe in BS2 and the scheduling of UE2 should therefore be delegated to BS2:

delegate(from=‘BS1’, to=‘BS2’, function=‘uplink scheduling’, object=‘UE2’)

In addition to where the measurements are available, one parameter affecting where scheduling should be performed is that the important co-scheduled UEs, preferably, should be allocated to the same node. So, if it from a ICIC perspective, for example due to strong co-channel interference, is important to co-schedule all three UEs in FIG. 8 in the same node, also the uplink scheduling of UE1 could be delegated to BS2:

delegate(from=‘BS1’, to=‘BS2’, function=‘uplink scheduling’, object=‘UE1’)

For downlink, the opposite may be desirable, i.e. to delegate the downlink scheduling function for UE3 to BS1, such that the downlink scheduling functions for all UEs are allocated to the high power node:

delegate(from=‘BS2’, to=‘BS1’, function=‘downlink scheduling’, object=‘UE3’)

In addition to measurement availability and interference relations, the traffic load and also user service can be taken into account when deciding on functional delegation. At low traffic load there is a gain with ICIC, and co-scheduling in the same node is an advantage, while at high traffic load, the gain can be lost, since the whole bandwidth is then better used in all nodes. For certain services, such as e.g. narrowband continuous user loads, the ICIC gain is larger and co-scheduling more important.

For a CoMP scheduler, similar UE specific delegation decisions as for an ICIC scheduler can be made. Mobile terminals with a strong relation to the same nodes should preferable be co-scheduled. For CoMP also the multi-path channel measurements are then needed, which requires more backhaul resources and delegation based on measurement availability is then more important. Further, for CoMP the orthogonality between the channels of different UEs may be taken into account.

### Alternative Embodiment 7

### Delegating eNB Functionality to Multiple Other eNBs

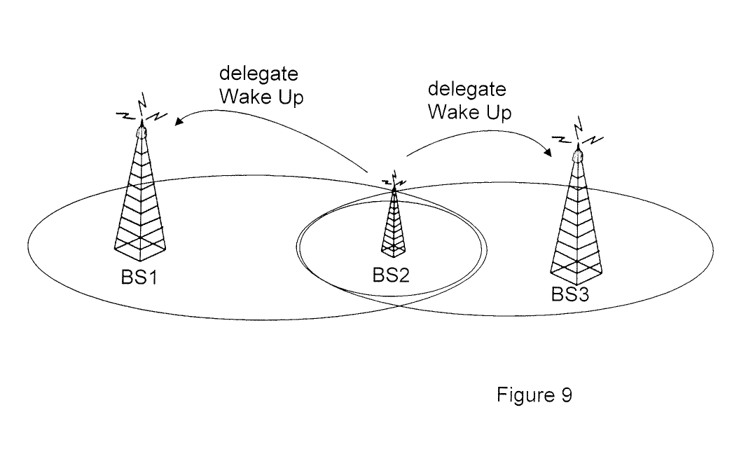

Below, a further embodiment will be described, with reference to FIGS. 8 and 9. A base station with small coverage, such as BS2 in FIG. 8, might be deployed by the operator to cope with the traffic in a hotspot. However, the traffic typically has large daily variations, especially in hotspots. Since the area covered by BS2 in FIG. 8 is covered by BS1 as well, BS1 may have enough capacity to handle the traffic outside the busy hours. In order to save energy, the operator may like to switch off the small cell covered by BS2 outside the busy hours.

FIG. 9 shows a situation in which the area covered by BS2 is covered also by the access points BS1 and BS3. BS1 and BS3 will both start serving parts of the area covered by BS2, when BS2 is switched off. BS2 might be started when either of BS1 or BS3 becomes capacity limited.

In this exemplifying embodiment, BS2 in FIG. 9 may decide to switch off in order to reduce energy consumption outside the busy hours. In order to do this, BS2 may delegate the wake up function to BS1 and BS3 by sending the message:

delegate(from=‘BS2’, to={‘BS1’, ‘BS3’}, function=‘wake_up’, object=‘BS2’)

The procedure is essentially the same as in the first embodiments, but this time it is an eNB function, which is delegated. This is a generalization of the first embodiments, where the function was a UE function, which was delegated to only one node. It can be implemented as a multicast message, or as a set of messages, each of them addressed to one BS, as in the first embodiment.

The object of the delegated function is a base station itself, unlike the previous embodiments where the objects were UEs.

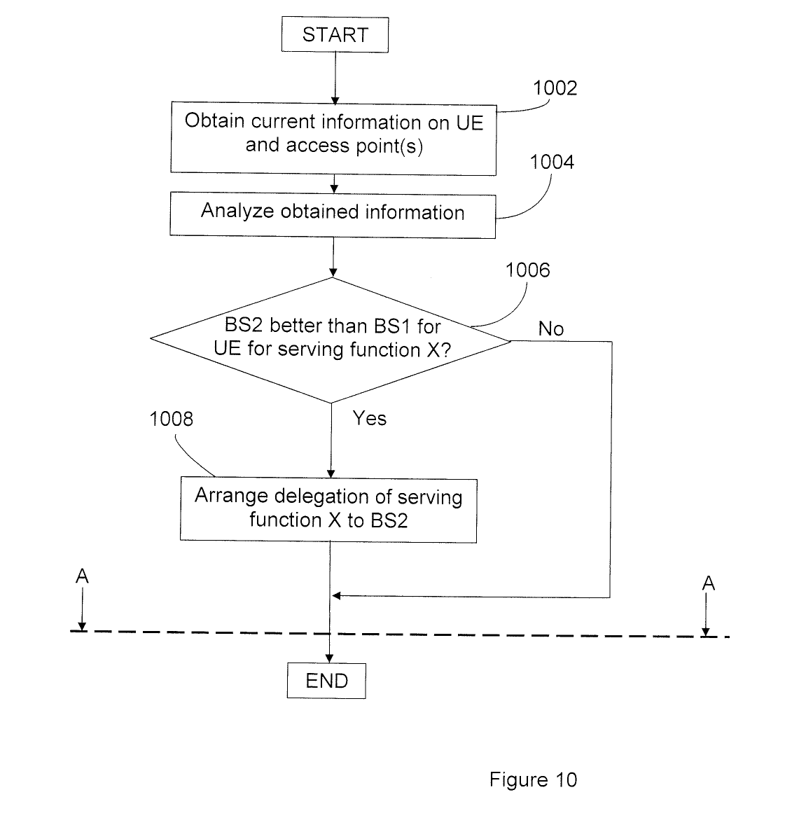

### Exemplifying Procedures, FIG. 10-13

Below, exemplifying embodiments of the procedure of delegating serving functions will be described with reference to FIGS. 10-13. The procedure is to be performed in a network node which manages a mobile terminal (UE). The network node may be an access point, such as e.g. an eNB, a Node B or an RRU (Remote Radio Unit), or, a control node, such as e.g. an RNC, a centralized RRM (Radio Resource Management) server, or a master RRM Node B controlling other Node Bs.

First, an exemplifying embodiment of a procedure for delegating serving functions will be described with reference to FIG. 10. Initially, information is obtained in an action 1002. The obtained information is related to the UE and to one or more access points, and comprises information of e.g. currently experienced radio conditions, load, the channel quality between the UE and one of the access points, UE speed and/or UE location. The information may be obtained e.g. through the receiving of standard handover measurement reports sent from the UE to the network node. Further, UEs may be configured to report measurements to access points or control nodes, and/or, measurements may be performed by access points on uplink transmissions/pilots/sounding signals from UEs. These measurements may be sent/exchanged between nodes e.g. over X2 or Iub. Load and uplink interference may be measured by access points and sent to other.

The obtained information is analyzed in an action 1004, and then it may be determined in an action 1006, whether a second access point is more suitable than a first access point for executing one or more serving functions related to the mobile terminal. The UE is assumed to be presently served by the first access point. The determining is based on the analyzed information and predefined criteria, such as e.g. threshold values. The first access point may be the network node in which the procedure is performed. The evaluated serving functions could be, e.g., data reception or transmission, HARQ, Link Adaptation, Power Control and/or scheduling in downlink or uplink.

When it is determined that a second access point is more suitable for executing one or more of the serving functions, it is arranged, in an action 1008, such that said one or more serving functions are delegated from the first access point to the second access point. The overall responsibility for the managing of the UE remains in the network node, even though at least one serving function is delegated to the second access point, i.e. it is not a conventional handover. The fact that the network node retains the overall responsibility for the managing of the UE implies that the network node can also revoke the delegation when e.g. the radio conditions changes.

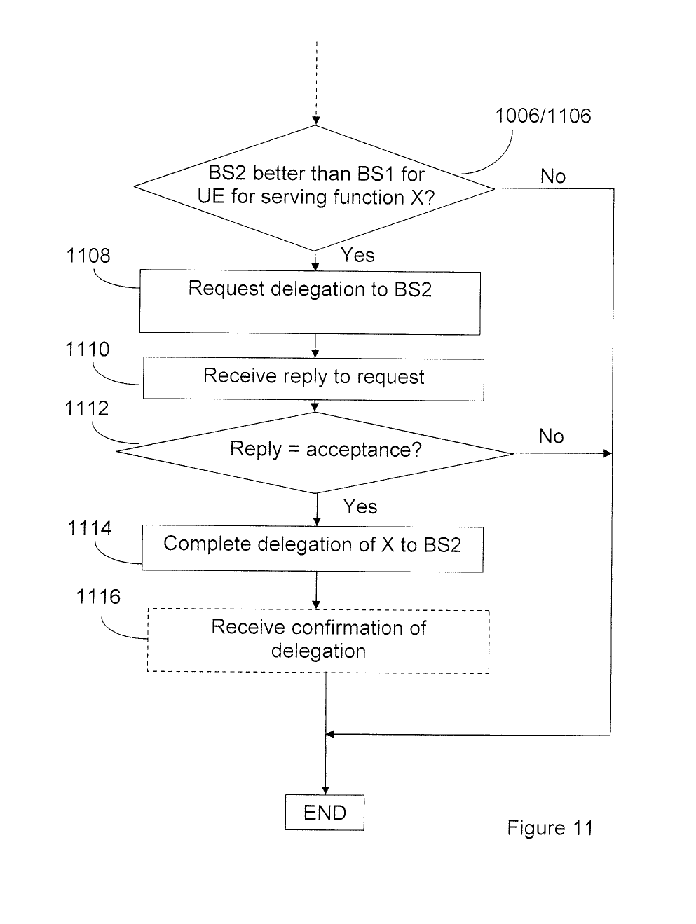

When the above described procedure is performed in a control node, the action 1008 could involve e.g. the sending of a delegation order to an access point serving the UE with the function(s) to be delegated. The delegation order could identify the function(s) to be delegated and the object to which the function(s) are related. When RRUs are used, a single Node B may control a number of RRUs. UEs are connected to the RRUs or to the Node B directly, while the Node B is the anchor for all UEs. When an RRU is capable of performing some of the RLC and/or RRC functions, the Node B could delegate functions to the RRU access point. An RRU could in this case be described as a small BS with limited baseband processing. An exemplifying set of actions comprised in the action 1008 when the above described procedure is performed in the access point which currently is executing the one or more serving functions which are to be delegated, is illustrated in FIG. 11.

An exemplifying embodiment of the above described procedure for delegating serving functions will now be described with reference to FIG. 11. Initially, a request for permission to delegate may be sent to the second access point in an action 1108. The request could identify the function(s) to be delegated and the object to which the function(s) are related. A reply from the second access point to the request may be received in an action 1110. Further, it may be determined in an action 1112, based on the reply, whether the request is accepted or rejected by the second access point. When the request is accepted by the second access point, the delegation could be completed by the network node in an action 1114. The completion may involve the transmission of a “delegation complete” message to the second access point, and may further involve the initiation and/or execution of a transfer of information to the second access point, which information, as previously described, may be needed in order for the second access point to be able to take over the execution of the delegated serving functions. Examples of such information are, e.g., scrambling code to enable communication to and from the UE, addressing information receiving and transmitting on correct frequency, time and code resources. There are also other more function specific information such as; SNR(Signal to Noise Ratio)-target for closed loop power control, BLER (Block Error Rate)-target for HARQ and LA and QoS information for scheduling. This information can be conveyed e.g. over a conventional information channel between the nodes. When all information is transferred, a confirmation may be received from the second access point in an action 1116.

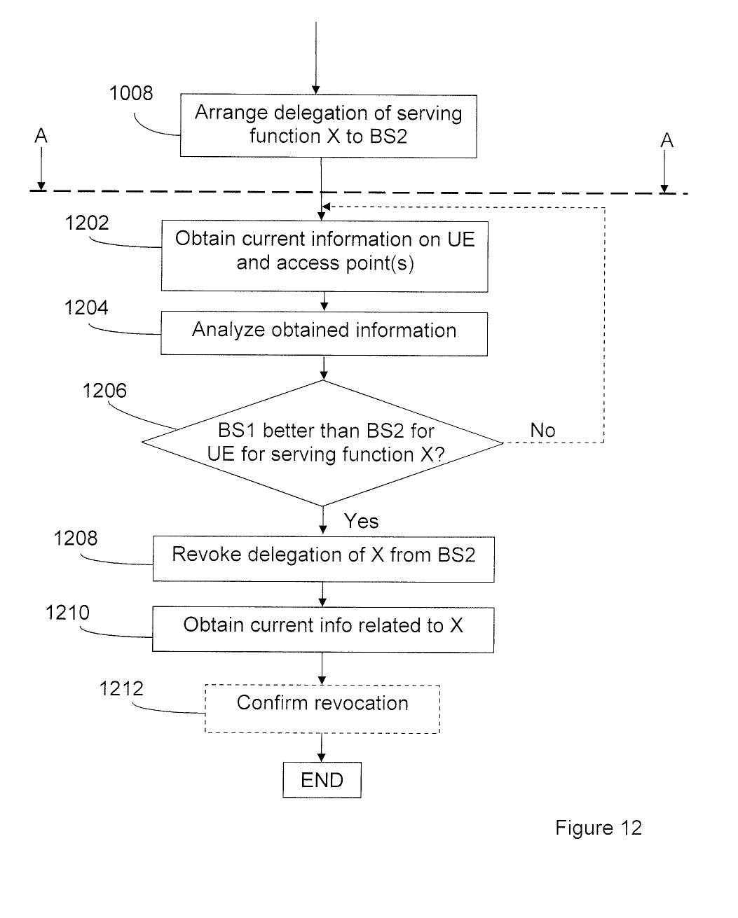

FIG. 12 illustrates an exemplifying procedure enabling the revocation of delegated serving functions. When a delegation has been completed, and the second access point has taken over the execution of the one or more serving functions in question, the network node continuously, or e.g. at certain intervals, evaluate whether the second access point is still more suitable than the first or e.g. a third access point for executing the delegated serving functions, in the actions 1202-1206. When it is determined in action 1206 that another access point than the second access point is more suitable, the one or more delegated serving functions may be revoked from the second access point in an action 1208. When the procedure is to be performed in a control node, the revocation in action 1208 could involve the ordering of a revocation of the delegated serving function(s) from the second access point to the first access point, identifying the involved components.

When the procedure is to be performed in an access point, the revocation action 1208 may involve the sending of a revocation message to the second access point, identifying the serving function(s) to be revoked, and the UE with which the serving functions are associated. Then, when required, information needed for the execution of the revoked serving functions may be obtained in an action 1210. The information could e.g. be comprised in or associated with a received revocation message from the second access point, or be received or retrieved separately, possibly over another interface than the revocation message. When the revocation is completed, this may be confirmed to the second access point, e.g. in form of the transmission of a confirmation message.

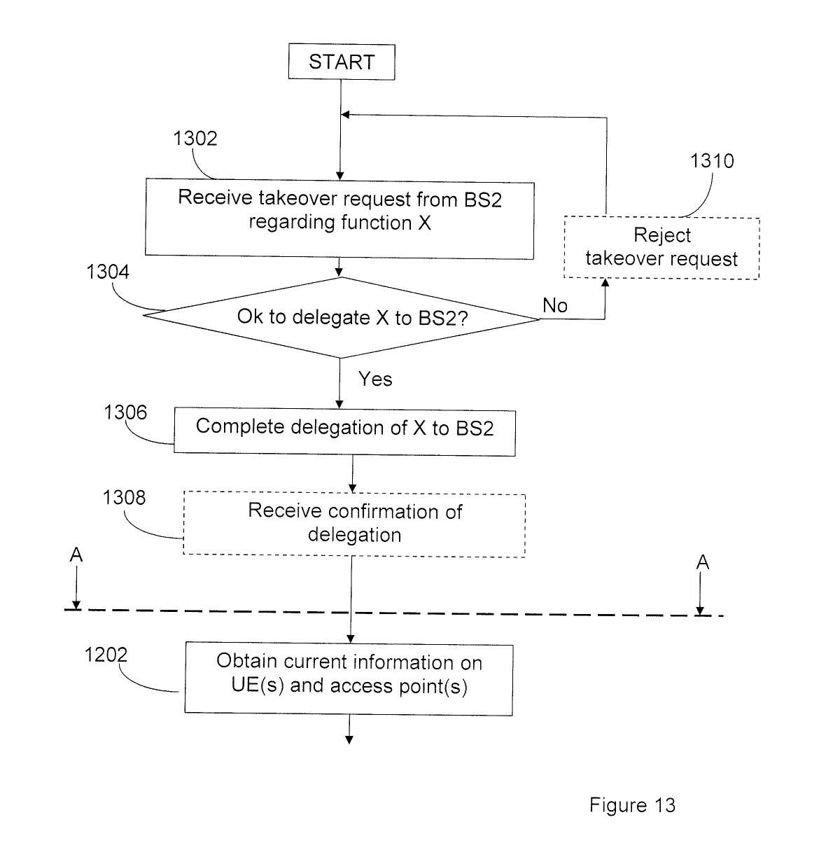

FIG. 13 illustrates an exemplary procedure in a network node when a second access point may request the takeover of one or more serving functions. The second access point may be e.g. a Node B, eNodeB or an RRU. Such a takeover request may be received by the network node in an action 1302. Then, it may be determined in an action 1304, whether it is appropriated to delegate, or let take over, the requested function(s) for the requested objects (UEs). When the request is related to monitoring the uplink, the requested objects will be “all UEs” connected to the network node. Whether it is appropriated or not to delegate could be determined e.g. based on obtained or available information related e.g. to security, access point type, characteristics, conditions and/or settings. For example, a home eNB may not be trusted e.g. to monitor or serve the UEs in a nearby macro cell. When determined that it is not appropriate to delegate the requested function(s) to the second access point, the request is rejected in an action 1310.

When it is determined that it is allowed and appropriate to delegate the requested function(s) to the second access point, the delegation is completed in an action 1306. This could, as previously described in conjunction with FIGS. 10 and 11, involve different actions depending on whether the network node is a control node or an access point. A confirmation or the completed delegation may be received in an action 1308. The delegated function(s) may be revoked when the second access point is no longer found to be suitable for executing the delegated function(s).

In case the second access point, or any access point, goes down, due to e.g. power failure, component failure and/or sabotage, when being responsible for executing one or more delegated serving functions, there should be a fallback procedure, assuring that the delegated functions are taken over by another access point. Such a fallback procedure could involve monitoring of e.g. the state of access points to which serving functions have been delegated, and resuming the execution of the functions delegated to an access point when detecting that said access point is unable or fails to execute the delegated function.

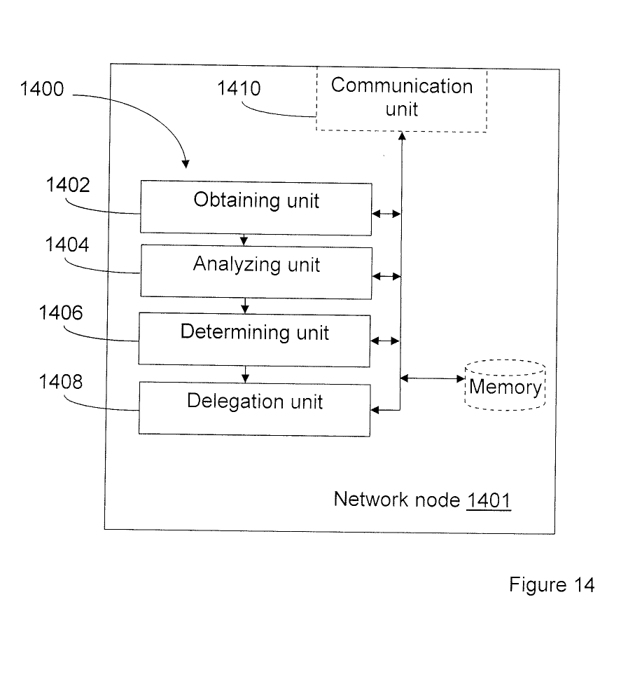

### Exemplifying Arrangement, FIG. 14

Below, an example arrangement 1400, adapted to enable the performance of one or more of the above described procedure(s) related to delegation, will be described with reference to FIG. 14. The arrangement is illustrated as being located in a network node 1401, adapted to manage a mobile terminal in a cellular communication system. The network node could, as previously described, be an access point, such as e.g. an eNB, Node B or an RRU, or, a control node, such as e.g. an RNC, a centralized RRM server, or a master RRM Node B controlling other Node Bs. The arrangement 1400 is further illustrated to communicate with other entities via a communication unit 1410 which may be considered to comprise conventional means for wireless, and possibly wired, communication.

The arrangement 1400 comprises an obtaining unit 1402, which is adapted to obtain information on the mobile terminal and at least one access point. The obtained information could relate to e.g. Radio Link Control and/or Radio resource Control, such as e.g. currently experienced radio conditions, load, the channel quality between the UE and an access points. The arrangement 1400 further comprises an analyzing unit 1404, adapted to analyze the obtained information, e.g. by comparing different values. The arrangement 1400 further comprises a determining unit 1406, which is adapted to determine, based on the analysis and predefined criteria, whether a second access point is more suitable than a first access point for executing one or more serving functions related to the mobile terminal. The evaluated serving functions could be, e.g., HARQ, Link Adaptation, Power Control and/or scheduling in downlink or uplink.

The arrangement 1400 further comprises a delegation unit 1408, which is adapted to arrange such that the one or more serving functions are delegated from the first access point to the second access point, while keeping the overall responsibility for the managing of the mobile terminal. The arranging may involve different actions depending on whether the network node is a control node or an access point, as previously described. The fact that the network node keeps the overall responsibility for the managing of the mobile terminal implies that the network node may revoke the delegated serving functions when e.g. necessary, appropriate or convenient, e.g. when certain predefined criteria are fulfilled.

Thus, the arrangement may further be adapted to perform revocation of a delegated function, e.g. to send a revocation order, and to obtain information needed for executing the revoked function. The arrangement may further be adapted to handle requests for “takeover”, or delegation, of serving functions, from other nodes, which handling may involve e.g. evaluation of the nodes, which request to take over a serving function, and deciding whether to delegate the requested function to the requesting node or not.

The arrangement may further be adapted to receive a request from another network node for taking over one or more serving functions. The arrangement could be adapted to evaluate the other network node, e.g. with respect to security, to delegate a function to the network node, if found to be trusted, and to reject the takeover request if the network node is found not to be trusted.

The arrangement may further be adapted to handle a situation where the access point to which a serving function is delegated is unable to execute said function. The arrangement could be adapted to provide a fallback involving e.g. monitoring of the state of access points, to which serving functions have been delegated, and further adapted to resume the execution of the functions delegated to an access point when detecting that said access point is unable or fails to execute the delegated function.

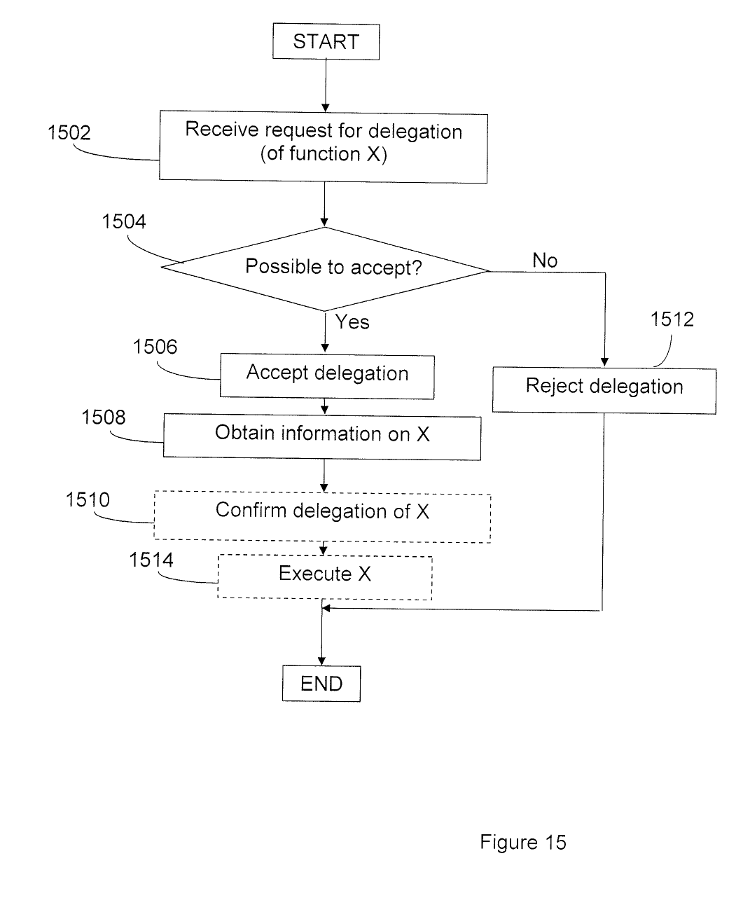

### Exemplifying Procedures, FIGS. 15-17

Below exemplifying embodiments of the procedure of receiving a delegation of serving functions will be described with reference to FIG. 15-17. The procedure is to be performed in an access point, such as e.g. an eNB, Node B or RRU.

FIG. 15 illustrates an exemplifying procedure in an access point, such as the access point being denoted “second access point” above. Initially, a delegation request related to a serving function and a UE is received in an action 1502. The request origins from a requesting network node, such as the network node described above, and may identify the requesting node, the serving function(s) to be delegated, and the UE associated with the serving functions. The information on the function and UE could alternatively be provided in another message, e.g. associated with the request. Then, it is determined in an action 1504, whether the request could be accepted or not, based on e.g. processing capacity. In case the functions(s) to be delegated are not identified in the request, a predefined template of e.g. the average processing requirements of a delegated serving function could be used. In case the request can be accepted, the acceptance is indicated to the requesting node in an action 1506. When it is determined that the request should be rejected, the rejection is indicated to the requesting node in an action 1512.

Some additional information related to the delegated serving function(s) may be required in order for the access point to be able to execute the delegated serving function(s). Such information may be received, or retrieved, in an action 1508. When applicable and appropriate, the delegation may be confirmed in an action 1510, e.g. by the transmission of a confirmation message. The confirmation may imply e.g. that the access point now will commence executing the delegated serving function(s) for the indicated UE. Action 1510 is optional, and is therefore illustrated with a dashed outline. The function is then executed, which is illustrated as the action 1514. However, the actual execution of the function may or may not be considered as a part of the delegation process. Therefore, action 1514 is illustrated with a dashed outline.

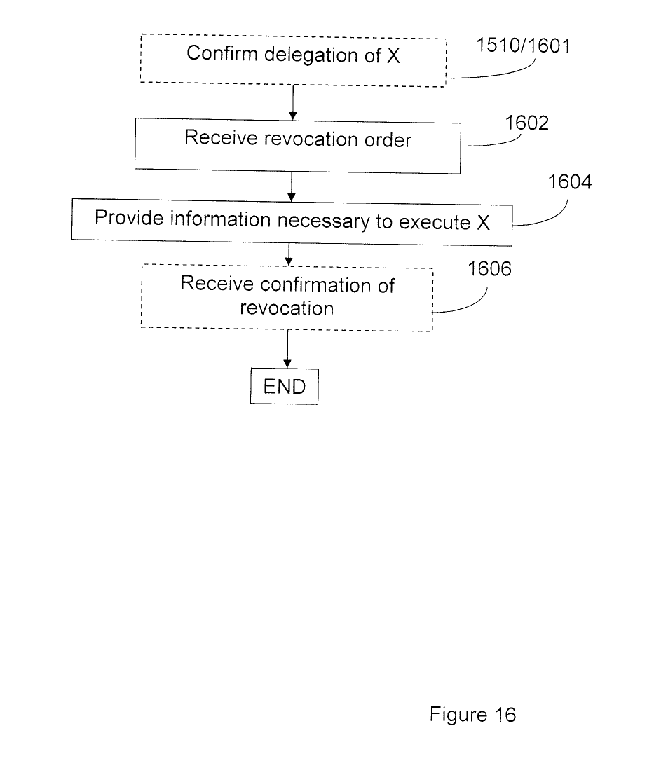

As previously mentioned, a delegating node could also revoke delegated functions. FIG. 16 illustrates an exemplifying procedure in an access point, from which one or more delegated serving functions are revoked. Initially, a revocation order is received in an action 1602, identifying the revoking node, the one or more functions to be revoked, and the UE(s) associated with the serving functions. In order to assist the revocation, information enabling the execution of the revoked serving function may be provided to the revoking node, when applicable. The information may be comprised in, or associated with, a transmitted “revocation complete” message, or similar. The information may also be conveyed to the revoking node, e.g. over an inter access point interface. A confirmation of the revocation may be received in an action 1606. After having provided the information enabling another node to execute the revoked serving functions, the access point may cease to execute said serving functions for the UE(s) in question.

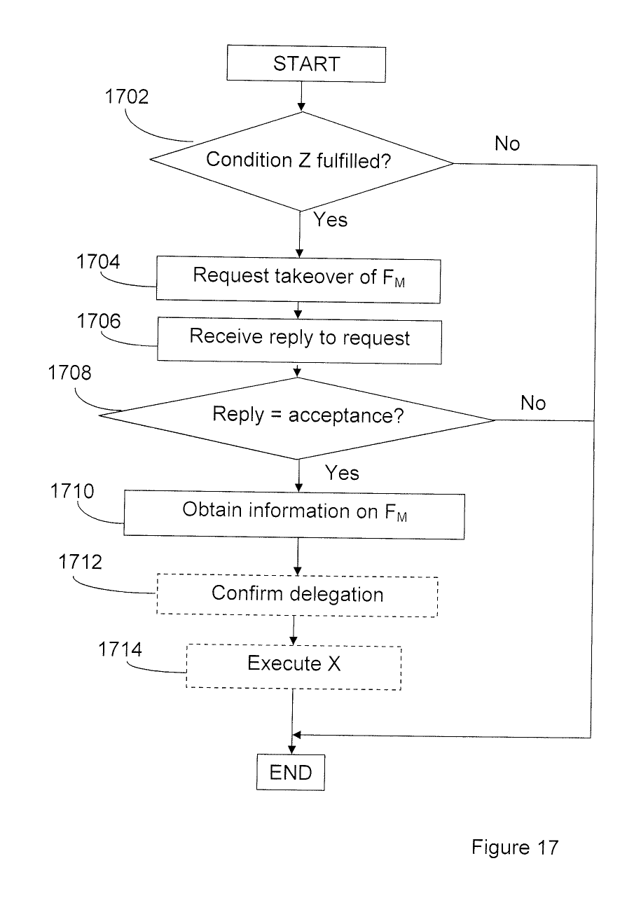

FIG. 17 illustrates an exemplifying procedure in an access point which requests to take over a serving function from a delegating node. Initially, it is determined in an action 1702 whether a certain condition is fulfilled. The condition could be e.g. that the interference has risen above a certain level or that a UE would be better served by the access point. In order to be able to identify a UE which possibly causes the increased interference, the access point may request to take over monitoring of the uplink of all UEs connected to another access point, in an action 1704. Serving functions, such as e.g. monitoring, are not literally “taken over”, since the delegating node will continue to perform such functions also after “takeover” or delegation. A reply to the request may be received in an action 1706. Further, it may be determined in an action 1708, whether the received reply is an acceptance or a rejection. When determined that the request has been accepted, information related to the requested function(s), enabling the access point to execute the requested function(s) may be obtained in an action 1710. A confirmation, e.g. implying that the access point will now commence executing the overtaken serving function, may be sent in an action 1712. The action 1712 is optional, and is thus illustrated having a dashed outline. The function is then executed, which is illustrated as the action 1714. However, the actual execution of the function may or may not be considered as a part of the delegation process, thus action 1714 is illustrated with a dashed outline.

When the access point has acquired the ability to monitor the uplink e.g. of the UEs in the vicinity, other serving functions for a specific UE could be requested. For example, when having identified a UE which causes severe interference to the access point, the access point may request to take over the scheduling of said UE, performing e.g. the actions 1702-1714.

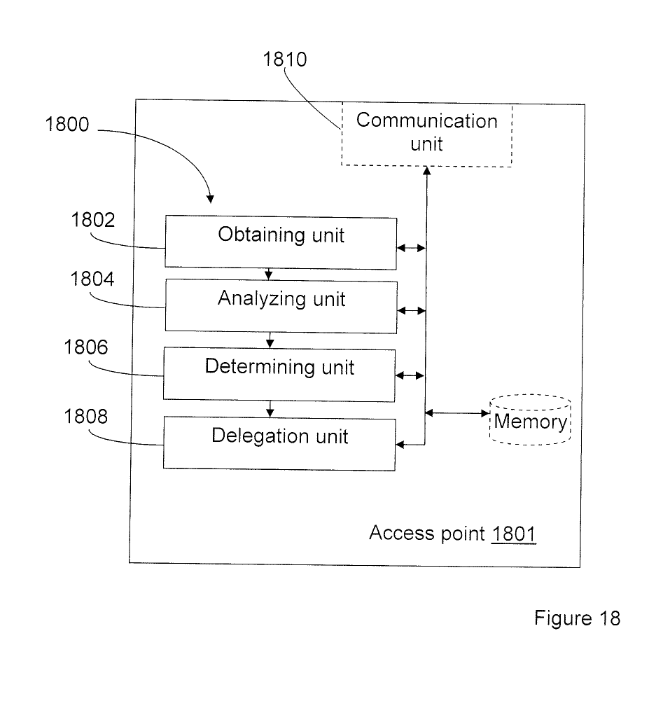

### Exemplifying Arrangement, FIG. 18

Below, an example arrangement 1800, adapted to enable the performance of one or more of the above described procedure(s) related to delegation, will be described with reference to FIG. 18. The arrangement is illustrated as being located in an access point 1801 in a cellular communication system. The access point could be e.g. an eNB, Node B or RRU. The arrangement 1800 is further illustrated as to communicate with other entities via a communication unit 1810 which may be considered to comprise conventional means for wireless, and possibly wired, communication. The arrangement or access point is assumed to comprise means for executing the functions delegated to the access point.

The arrangement 1800 comprises an obtaining unit 1802, adapted to receive a delegation request from a requesting network node. The arrangement 1800 further comprises a determining unit 1806, which is adapted to determine whether the request could be accepted or not, based e.g. on the processing capacity in the access point. The determining unit 1806 could possibly be assisted by analyses of e.g. conditions of the access point, made in an analyzing unit 1804, adapted thereto. The arrangement 1800 further comprises a delegation unit 1808, which is adapted to indicate the result of the determining to the requesting node.

The arrangement may further be adapted to obtain information enabling the execution of the delegated serving function, when the delegation is accepted, and be adapted to execute the delegated serving function.

The arrangement may further be adapted to receive a revocation order, related to the delegated serving function, from a revoking node. The arrangement may further be adapted to assist the revocation by providing information, which enables the execution of the revoked serving function, to the revoking node.

The arrangement may further be adapted to request the takeover, or delegation, of a serving function. This could be performed e.g. when certain criteria are fulfilled, such as that a certain interference level is reached. Assuming that the access point is allowed to monitor the uplink of UEs located in the vicinity, the access point could request to take over e.g. scheduling and/or link adaptation for a certain UE.

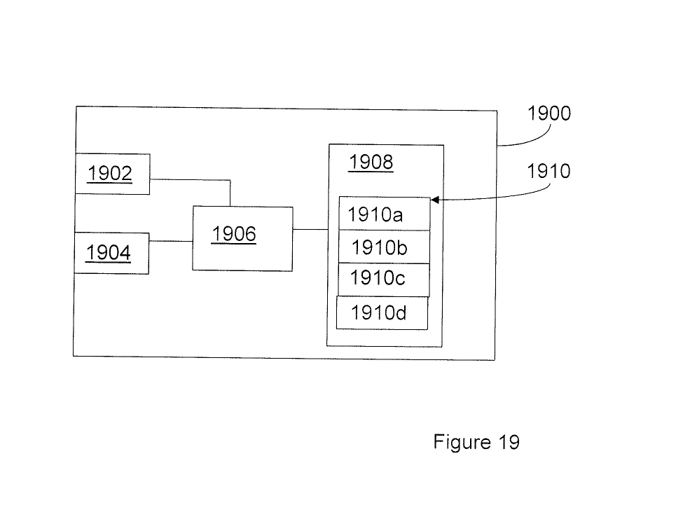

### Exemplifying Arrangement, FIG. 19

FIG. 19 schematically shows an embodiment of an arrangement 1900 in a video decoding entity, which also can be an alternative way of disclosing an embodiment of the arrangement for delegation of serving functions in a network node, illustrated in FIG. 14. Comprised in the arrangement 1900 are here a processing unit 1906, e.g. with a DSP (Digital Signal Processor) and an encoding and a decoding module. The processing unit 1906 can be a single unit or a plurality of units to perform different actions of procedures described herein. The arrangement 1900 may also comprise an input unit 1902 for receiving signals from other nodes or entities, and an output unit 1904 for providing signal(s) to other nodes or entities. The input unit 1902 and the output unit 1904 may be arranged as an integrated entity.

Furthermore, the arrangement 1900 comprises at least one computer program product 1908 in the form of a non-volatile memory, e.g. an EEPROM (Electrically Erasable Programmable Read-Only Memory), a flash memory and a hard drive. The computer program product 1908 comprises a computer program 1910, which comprises code means, which when executed in the processing unit 1906 in the arrangement 1900 causes the arrangement and/or the network node to perform the actions of the procedure described earlier in conjunction e.g. with FIG. 10.

The computer program 1910 may be configured as a computer program code structured in computer program modules. Hence in the example embodiments described, the code means in the computer program 1910 of the arrangement 1900 comprises an obtaining module 1910a for obtaining current information on a mobile terminal and at least one access point. The computer program further comprises an analyzing module 1910b, for analyzing the obtained information. The computer program further comprises a determining module 1910c for determining whether a second access point is more suitable than a first access point for executing one or more serving functions related to the mobile terminal, based on the analysis and predefined criteria. The computer program further comprises a delegating module 1910d, for arranging such that the one or more serving functions are delegated from the first access point to the second access point.

The modules 1910a-d could essentially perform the actions of the flow illustrated in any of the FIGS. 10-13, to emulate the arrangement in a network node illustrated in FIG. 14. In other words, when the different modules 1910a-d are executed in the processing unit 1906, they correspond to the units 1402-1408 of FIG. 14.

Similarly, a corresponding alternative to the arrangement illustrated in FIG. 17 is also possible.

Although the code means in the embodiment disclosed above in conjunction with FIG. 19 are implemented as computer program modules which when executed in the processing unit causes the arrangement and/or network node to perform the actions described above in the conjunction with figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as ASICs (Application Specific Integrated Circuit). The processor may also comprise board memory e.g. for caching purposes. The computer program may be carried by a computer program product connected to the processor. The computer program product comprises a computer readable medium on which the computer program is stored. For example, the computer program product may be a flash memory, a RAM (Random-access memory) ROM (Read-Only Memory) or an EEPROM, and the computer program modules described above could in alternative embodiments be distributed on different computer program products in the form of memories within the network node.

While the procedure as suggested above has been described with reference to specific embodiments provided as examples, the description is generally only intended to illustrate the inventive concept and should not be taken as limiting the scope of the suggested methods and arrangements, which are defined by the appended claims. While described in general terms, the methods and arrangements may be applicable e.g. for different types of communication systems, using commonly available communication technologies, such as e.g. GSM/EDGE, WCDMA, WiMax or LTE. Further, the methods and arrangements may be applicable in cellular communication systems having a flat architecture as well as in cellular communication systems having an hierarchical architecture.

Within this document, the delegation of one or more serving functions from one network node to another has been described. The overall responsibility for the serving functions remains in the delegating node. In case all or e.g. a majority of the serving functions related to a certain UE have been delegated to another network node, it may be considered whether said UE should be handed over to the other network node, e.g. by that the overall responsibility is transferred, possibly together with the remaining serving functions, to the other network node.

The described node interaction (delegation, monitoring request and information messages) may be sent over different types of communication resources, interfaces and protocols. For example, for LTE the information may be sent e.g. over the X2 interface between eNodeB:s, for WCDMA over the Iub interface between RNC and nodeB. The method and arrangement is not limited to these examples and can be implemented over a large variety of communication interfaces and protocols such as e.g. Ehternet and/or IP.

It is also to be understood that the choice of interacting units or modules, as well as the naming of the units are only for exemplifying purpose, and network nodes suitable to execute any of the methods described above may be configured in a plurality of alternative ways in order to be able to execute the suggested process actions. For example the RRU can have capability of a range of functions from only layer 1 radio reception and forwarding up to an eNodeB full functionality. Similarly a nodeB can have different degrees of functional capability enabling delegation of all RNC functions.

It should also be noted that the units or modules described in this disclosure are to be regarded as logical entities and not with necessity as separate physical entities.

### REFERENCES

[1] DOCOMO, 3GPP R1-084253

1-42. (canceled)

43. A method in a first network node managing a mobile terminal in a cellular communication system, the method comprising:
obtaining information on the mobile terminal and at least one access point;
analyzing the obtained information and based on the analysis and predefined criteria, determining whether a second access point is more suitable than a first access point for executing one or more serving functions related to the mobile terminal; and
when a second access point is found to be more suitable for executing one or more of the serving functions, arranging such that the one or more serving functions are delegated from the first access point to the second access point, while keeping the overall responsibility for the managing of the mobile terminal.

44. The method according to claim 43, wherein the one or more serving functions are related to Radio Link Control and/or Radio Resource Control.

45. The method according to claim 43, wherein each of the one or more serving functions is related to one of the following: Hybrid Automatic Repeat reQuest (HARQ), link adaptation, power control, and scheduling.

46. The method according to claim 43, wherein the first and second access points are base stations.

47. The method according to claim 43, wherein the first network node and the first access point are the same node.

48. The method according to claim 43, wherein the first network node is a control node.

49. The method according to claim 48, wherein the delegation is arranged by the transmission of a delegation order to the first access point.

50. The method according to claim 43, wherein the delegation to the second access point involves the transmission of a delegation request to the second access point.

51. The method according to claim 50, further comprising the receiving of a reply to the delegation request from the second access point, stating whether the request for delegation is accepted or rejected by the second access point.

52. The method according to claim 43, further comprising, at least when the delegation is accepted by the second access point, providing information related to the at least one serving function to be delegated to the second access point, thus enabling the second access point to execute the at least one serving function.

53. The method according to claim 43, further comprising receiving a confirmation indicating that the delegation to the second access point has been successfully completed.

54. The method according to claim 43, wherein a serving function is delegated to a plurality of nodes.

55. The method according to claim 43, further comprising, when one or more serving functions related to a mobile terminal are delegated from the first access point to a second access point:
analyzing information on the mobile terminal and at least one access point;
determining, based on the analysis and the predefined criteria, whether the first access point or a third access point is more suitable for executing one or more of the one or more serving functions delegated to the second access point; and
when the first or third access point is found to be more suitable for executing at least one of the one or more delegated serving functions, arranging such that the one or more delegated serving functions are revoked from the second access point.

56. The method according to claim 55, wherein the revocation involves the transmission of a revocation order to the second access point, identifying the at least one serving function to be revoked and the concerned mobile terminal.

57. The method according to claim 55, wherein the revocation involves receiving information in the first access point enabling the execution of the at least one revoked serving function, as revoked from the second access point.

58. The method according to claim 55, wherein the revocation involves confirming the revocation to the second access point when the revocation has been successfully completed.

59. The method according to claim 43, further comprising:
monitoring the state of the second access point; and
resuming the execution of a delegated function when the second access point fails to execute said function.

60. An arrangement in a first network node in a cellular communication system, the arrangement comprising:
an obtaining unit, adapted to obtain information on a mobile terminal managed by the first network node, and at least one access point;
an analyzing unit, adapted to analyze the obtained information;
a determining unit, adapted to determine, based on the analysis and predefined criteria, whether a second access point is more suitable than a first access point for executing one or more serving functions related to the mobile terminal; and
a delegation unit, adapted to arrange such that the one or more serving functions are delegated from the first access point to the second access point when the second access point is found to be more suitable for executing the one or more serving functions, while keeping the overall responsibility for the managing of the mobile terminal.

61. The arrangement according to claim 60, wherein the first and second access points are base stations.

62. The arrangement according to claim 60, wherein the first network node and the first access point are the same node.

63. The arrangement according to claim 60, wherein the first network node is a control node.

64. The arrangement according to claim 63, further adapted to arrange the delegation by the transmission of a delegation order to the first access point.

65. The arrangement according to claim 60, further adapted to arrange the delegation by the transmission of a delegation request to the second access point.

66. The arrangement according to claim 65, further adapted to receive a reply to the delegation request from the second access point, stating whether the request for delegation is accepted or rejected by the second access point.

67. The arrangement according to claim 60, further adapted to provide information related to the at least one serving function to be delegated to the second access point, thus enabling the second access point to execute the at least one serving function.

68. The arrangement according to claim 60, further adapted to receive a confirmation indicating that the delegation to the second access point has been successfully completed.

69. The arrangement according to claim 60, further adapted to delegate a serving function to a plurality of nodes.

70. The arrangement according to claim 60, further adapted to, when one or more serving functions related to a mobile terminal are delegated from the first access point to a second access point:
analyze information on the mobile terminal and at least one access point;
determine, based on the analysis and the predefined criteria, whether the first access point or a third access point is more suitable for executing one or more of the one or more serving functions delegated to the second access point; and
when the first or third access point is found to be more suitable for executing at least one of the one or more delegated serving functions, arrange such that the one or more delegated serving functions are revoked from the second access point.

71. The arrangement according to claim 70, further adapted to revoke the at least one delegated serving function by the transmission of a revocation order to the second access point, identifying the at least one serving function to be revoked and the concerned mobile terminal.

72. The arrangement according to claim 70 further adapted to receive information from the second access point enabling the execution of the at least one revoked serving function.

73. The arrangement according to claim 70, further adapted to confirm to the second access point when the revocation has been successfully completed.

74. The arrangement according to claim 60, further adapted to monitor the state of the second access point, and to resume the execution of a delegated function when the second access point fails to execute said function.

75. A method in an access point in a in a cellular communication system, said method comprising:
receiving a delegation request related to a serving function and a mobile terminal, from a requesting network node;
determining whether the request could be accepted; and
indicating the result of the determining to the requesting node.

76. The method according to claim 75, further comprising, when it is determined that the request could be accepted, obtaining information enabling the execution of the delegated serving function and executing the delegated serving function.

77. The method according to claim 76, further comprising:
receiving a revocation order related to the delegated serving function from a revoking node; and
providing information enabling the execution of the revoked serving function to the revoking node.

78. The method according to claim 75, further comprising requesting the delegation of a certain serving function from a network node to the access point.

79. The method according to claim 75, further comprising:
monitoring at least one network parameter; and
determining whether delegation of a serving function should be requested from the network node.

80. An arrangement in an access point in a cellular communication system, said arrangement comprising:
an obtaining unit, adapted to receive a delegation request from a requesting network node;
a determining unit, adapted to determine whether the request could be accepted; and
a delegation unit, adapted to indicate the result of the determining to the requesting node.

81. The arrangement according to claim 80, further adapted to obtain, when it is determined that the request could be accepted, information enabling the execution of the delegated serving function, and adapted to execute the delegated serving function.

82. The arrangement according to claim 81, further adapted to receive a revocation order from a revoking node, related to the delegated serving function, and to provide information enabling the execution of the revoked serving function to the revoking node, when required.

83. The arrangement according to claim 80, further adapted to request the delegation of a certain serving function from a network node to the access point.

84. The arrangement according to claim 80, further adapted to monitor at least one network parameter and determine whether delegation should be requested from a network node.
